(19) United States
(12) Patent Application Publication
(10) Pub. No.: US 2012/0247368 A1
(43) Pub. Date: Oct. 4, 2012

(54) PATTERN-FORMING OBJECTS FOR INCORPORATION INTO COATING MATERIAL COMPOSITION

(76) Inventors: Hiromichi Kano, Okayama (JP); Ying-Chiao She, Okayama (JP)

(21) Appl. No.: 13/502,735

(22) PCT Filed: Oct. 19, 2010
(86) PCT No.: PCT/JP2010/068405

§ 371 Date: Apr. 18, 2012

(30) Foreign Application Priority Data
Oct. 19, 2009 (JP) 2009-240786

(51) Int. Cl. C09D 105/12; C08L 5/12

(52) U.S. Cl. 106/205.01; 106/501.1

(57) ABSTRACT

Provided is a group of pattern-forming objects which (1) retain shapes thereof prior to application and (2) easily collapse during application and which (3) can be easily and inexpensively produced. It is the group of pattern-forming objects comprising a plurality of pattern-forming objects gelled with agar to be combined into a coating material composition. The pattern-forming objects exhibiting different color may be comprised, or the pattern-forming objects may comprise a pigment or a coloring agent, or at least one of the pattern-forming objects may comprise an aggregate in a powder state or in a granular state.

### TECHNICAL FIELD

The present invention relates to a group of pattern-forming objects for incorporation into a coating material composition, and more specifically relates to a group of pattern-forming objects to be combined with the coating material composition which constitutes a coating film having a variety of patterns by applying once the coating material composition. The coating material composition combined with the group of pattern-forming objects for incorporation into the coating material composition can be utilized to form irregular and various patterns on a coated surface since the pattern-forming objects constituting the group of pattern-forming objects collapse or are crushed thereon by the force applied during a process in which the coating material composition is applied onto a subject material.

### BACKGROUND ART

Various kinds of materials have been proposed as a multicolored-pattern coating material to cause formation of various ornamental coating films having a combination of many colors and tints by one-time application of the coating material composition, and one kind of them is a coating material composition into which a plurality of pattern-forming objects (a group of pattern-forming objects) to exhibit different hues from those of the coating film formed with a coating-film-forming composition are incorporated (for example, see Patent Reference 1, Patent Reference 2, and so on).

Patent Reference 1 describes “Among the coating compositions, a coating material to form a coating film having a variety of patterns by one-time application is called a variety-of-pattern coating material and defined by JIS K 5667. According to the definition, it is described “the multi-colored-pattern coating material is configured to be a composition with suspended particles having two or more than two colors respectively in a liquid form or a gelled form.” (see paragraph [0002] in Patent Reference 1) and “the multi-colored-pattern coating material exhibits formation of a pattern as the particles having two or more than two colors in a liquid form or a gelled form of the configuration are crushed.” (see paragraph [0004] in Patent Reference 1)

The invention described in Patent Reference 2 was made to “provide a water-base coating composition of a novel configuration and an application method of forming a multicolored pattern by using the composition” (paragraph [0007] of Patent Reference 2. In concrete, “it is a coating composition including a capsuled coating material dispersed in an aqueous dispersion medium of a water-based base (ground color) coating material, and the capsuled coating material is characterized in that color pigmented coating material is encapsulated inside a capsule film (hereinafter, the capsuled coating material is referred to as “capsuled color-pigmented coating material”.) and that the capsule film has such strength that the capsule film is broken by external force during an application operation. It is possible to form a multicolored pattern on a base coating film surface as the capsuled color-pigmented coating material kept inside is made to outflow or scattered by breaking the capsule film of the capsuled coating material with the external force (e.g., pressure by applicator) such as applicator pressure during the application operation since the coating composition is configured as described above.” (paragraphs 0009 to 0010 of Patent Reference 2) as disclosed therein.

The applicant of the present application also filed a patent application before to obtain the patent No. 2832424 for the invention, a configuration of which is “The coating material for forming a granitic varicolored pattern is obtained by kneading a group of flexible tough resin flakes of at least three colors and a binder which becomes substantially colorless and transparent when dried and cured. The resin flakes are irregular and random in size, have a margin gradually becomes thinner in the direction of the outer edge, are nonuniform in thickness and resemble coarse particles constituting granite in hue. Because the margins of the resin flakes become gradually thinner in the direction of their outer edges, they, when applied, form unnatural steps at their overlaps. Because of nonuniformity of thickness, they can give a coating film closely resembling natural granite in appearance and feeling. Because of their flexibility and the consequent deformation in application, any one that is not specially trained can give an even mottle-free finish in good workability.” (configuration as described in Abstract) in order to “obtain a single-coating one-package coating material which can give a natural granitic appearance to the wall surface of a building or the like.”

### PRIOR ART REFERENCES

### Patent References

[Patent Reference 1] Japanese Unexamined Patent Application Publication No. 2001-207126 (for example, Abstract, and paragraphs [0001] to [0004], etc. of the Detailed Description Of The Invention).

[Patent Reference 2] Japanese Unexamined Patent Application Publication No. 2006-63213 (for example, Abstract, and paragraphs [0001] to [0010] of the Detailed Description Of The Invention, FIGS. 1 and 2, and so on).

[Patent Reference 3] Japanese Unexamined Patent Application Publication No. H09-3368 (for example, Abstract, and paragraphs [0001], and [0027] to of the Detailed Description Of The Invention, FIGS. 1 to 3, and so on).

### DISCLOSURE OF THE INVENTION

### Problem to be Solved by the Invention

As disclosed in Patent Reference 1 and Patent Reference 2, a coating material composition (multicolored-pattern coating material) combined with a plurality of pattern-forming objects (a group of pattern-forming objects) in the coating-film-forming composition which forms a coating film was known while the plurality of pattern-forming objects exhibit different colors from those of the coating film formed with the coating-film-forming composition. It is preferable that the plurality of pattern-forming objects (the group of pattern-forming objects) to be combined with this coating material composition (1) retain their shapes in a stage such as manufacture, storage, shipping, and so on prior to the actual application operation, (2) are easily crushed or collapse (hereinafter, referred to “collapse”) to form a pattern, and (3) are easily and inexpensively manufactured.

However, it is generally difficult for the pattern-forming objects to have such a property to (1) retain their shapes in the stage prior to the actual application operation and (2) achieve an easy collapse during the application operation (they are usually incompatible factors: (1) ability to retain the shapes prior to the application operation and (2) easy collapse during the application operation, and they are in such a relationship that if one is improved then the other is deteriorated.) and such pattern-forming objects (the group of pattern-forming objects) that can achieve both of them have been eagerly awaited. And the capsuled coating material as the pattern-forming objects of Patent Reference 2 cannot be manufactured easily and inexpensively since it is necessary to encapsulate a color-pigmented coating material inside the capsule film.

In consideration of the above, it is an object to provide a group of pattern-forming objects to be compatible with both (1) ability to retain their shapes in the stage prior to the actual application operation and (2) easy collapse during the application operation; and so as to be (3) manufactured easily and inexpensively.

### Means to Solve the Problem

The present inventor devoted himself to develop a group of pattern-forming objects (a plurality of pattern-forming objects) which can be combined into a coating-film-forming composition including a water-based coating material that constitutes a coating film so as to configure a coating material composition for formation of a pattern, be compatible with (1) retainability of their shapes before the application operation and (2) easy collapse during the application operation, and be manufactured easily and inexpensively. As a result, the present inventor completed the present invention by finding that the group of pattern-forming objects can be formed by utilizing gelated material made from agar so as to satisfy these (1) to (3).

Thus, the group of pattern-forming objects (hereinafter, referred to as “group of present pattern-forming objects”) for incorporation into the coating material composition of the present invention is a group of pattern-forming objects for incorporation into the coating material composition including a plurality of pattern forming objects (hereinafter, referred to as “present pattern-forming objects”) of material gelled with agar.

Although the pattern forming objects of material gelled with agar can easily retain their shapes as they are difficult to be crushed or collapse in stages prior to the coating operation such as storage, shipping, and a mixing step of mixing the pattern forming objects into the coating-film-forming composition when the coating material composition is manufactured, the pattern forming objects collapse easily once force (mainly, shear force) is applied by a trowel and the like during the application operation of the coating material composition. And the agar is easily and inexpensively available and lacks toxicity, and it is easy to manufacture the agar gel such that it is possible to manufacture easily and inexpensively the group of pattern-forming objects (a plurality of pattern-forming objects). Further, material gelled with agar is stably suspended in the coating-film-forming composition comprised of water-based coating material.

As described above, when the group of present pattern-forming objects show different color from that of the coating film formed with the coating film forming composition comprised of water-based coating material and mixed with the coating-film-forming composition such that the coating material composition for forming a pattern can be formed, the pattern can be formed so as to show different color from that of the coating film formed with the coating-film-forming composition because the present pattern-forming objects included therein easily collapse while the coating material composition is applied with the force (mainly shear force) by a trowel or the like. And the group of present pattern-forming objects can be easily and inexpensively manufactured and the shapes of the pattern-forming objects can be successfully retained until the application operation (the issue that the pattern is not successfully formed is prevented or a degree of the issue is lowered since the pattern-forming objects are crushed or collapse before the application operation) such that the pattern can be formed as the collapsed pattern-forming objects show different color from that of the coating film formed with the coating-film-forming composition since the pattern-forming objects successfully collapse during the application operation.

The group of present pattern-forming objects can be made by including pattern-forming objects having different colors.

In this way, the group of present pattern-forming objects show different color from that of the coating film formed with the coating-film-forming composition such that, while the coating material composition for forming the patters, which is formed by mixing the group of present pattern-forming objects and the coating-film-forming composition, is applied by a trowel or the like with force (mainly shear force) being applied, the present pattern-forming objects included therein show different color, which forms the pattern.

Here, that the group of present pattern-forming objects includes pattern-forming objects having different color means that at least one pattern-forming object of the present pattern-forming objects has different color from that of another pattern-forming object, and all of the pattern-forming objects constituting the group of present pattern-forming objects may have different colors, respectively, or the group of present pattern-forming objects may also include some of the pattern-forming objects having the same color (for example, 15 of pattern-forming objects constituting the group of present pattern-forming objects may be comprised of 10 of the pattern-forming objects having the same red color, and 5 of the pattern-forming objects having the same blue color).

In the group of present pattern-forming objects, the pattern-forming objects may include pigment or colorant.

In this way, when the coating material composition for forming a pattern which is provided by mixing the group of present pattern-forming objects and the coating-film-forming composition is applied by the trowel or the like with force (mainly shear force) being applied, the pattern-forming objects can show desired color by making the pattern-forming objects include pigments or colorant such that the pattern having desired color can be successfully formed.

In the group of present pattern-forming objects, at least one of the pattern-forming objects may also be what includes aggregate in a power or grain state (hereinafter, referred to as “group of present pattern-forming objects using aggregate”).

The pattern-forming objects including aggregate in a powdery or granular state can easily retain their shapes in the prior stage before the coating operation such as manufacture, storage, and shipping, but the pattern can be formed successfully because collapse of the pattern-forming objects can be easily caused as the viscosity of the pattern-forming composition is suppressed by the addition of the aggregate when the coating material composition for forming a pattern which is provided by mixing the group of present pattern-forming objects and the coating-film-forming composition is applied by the trowel or the like with force (mainly shear force) being applied.

As the aggregate in a powdery or granular state to be combined with the pattern-forming objects, sand, mica powder, pearl powder, and so on can be named as examples, and the grain diameter of the aggregate is preferably at least 0.05 mm and more preferably at least 0.1 mm, normally as the lower limit, and is preferably not exceeding 5 mm and more preferably not exceeding 2 mm, as the upper limit, since it is difficult to be included by the pattern-forming objects if the grain diameter is too big while it is difficult to perform easy collapse thereof during the above-mentioned application process if the grain diameter is too small. Here, the grain diameter of the aggregate is what was measured by a method of metal mesh screen as defined by JISZ8801-1.

And the amount of aggregate to be combined with the pattern-forming objects is normally defined by the ratio (wb/wt) of the mass wb (dry mass excluding water content) of the aggregate combined into the pattern-forming objects and the total mass wt (dry mass excluding water content) of the pattern-forming objects, and the ratio is preferably at least 0.7 and more preferably at least 0.8, as the lower limit, and preferably not exceeding 0.98 and more preferably not exceeding 0.97, as the upper limit, since the aggregate is difficult to be included if the amount of aggregate is too much while the aggregate is difficult to perform the collapse nature.

In the case of the group of present pattern-forming objects using aggregate, pattern-forming objects not including the aggregate may be included in the group of present pattern-forming objects using aggregate.

When the coating material composition for forming a pattern which is formed with the group of present pattern-forming objects and the coating-film-forming composition is applied by the trowel or the like with force (mainly shear force) being applied, the viscosity of the pattern-forming objects is suppressed by the aggregate such that different collapse conditions are yielded between the pattern-forming composition including the aggregate and the pattern-forming composition not including the aggregate during the application operation if the pattern forming objects constituting the group of present pattern-forming composition comprise what includes the aggregate and what does not include the aggregate. Therefore, if the group of present pattern-forming objects using the aggregate includes the pattern-forming object not including the aggregate, it is possible to form a variety of patterns in which different collapse conditions are provided in between the pattern-forming objects. And on the surface of the coating film formed by applying two coating material compositions for forming a pattern, one of which includes the pattern-forming objects including the aggregate and the other of which includes the pattern-forming objects not including the aggregate, with a trowel or the like as the force (mainly shear force) is applied, roughness formed with the aggregate is yielded in a portion in which the pattern-forming objects including the aggregate while roughness formed with the aggregate is not yielded in a portion in which the pattern-forming objects not including the aggregate, thereby causing varied conditions of the surface of the coating film.

In the case of the group of present pattern-forming objects using the aggregate, the color exhibited by the pattern-forming objects including the aggregate may be the same type of color of the aggregate.

In this way, when the coating material composition for forming a pattern including the pattern-forming objects including the aggregate is applied by the trowel or the like with force (mainly shear force) being applied, the color exhibited by the pattern-forming objects and the color exhibited by the aggregate included in the pattern-forming objects are the same type of color such that it is possible to form a pattern not causing a sense of discomfort.

Here, that both colors are the same type of color means that, in the hue arrangement of the Munsell color system (10 hues), one hue to which one of both colors belongs and the other hue to which the other of both colors belongs are (A) in the same hue, (B) in neighboring hues, respectively, or (C) in separate hues sandwiching another hue inbetween, but (A) or (B) is preferable and (A) is the most preferable.

In the group of present pattern-forming objects, the pattern-forming objects may include an additive having antibacterial activity.

In this way, the preserving property of the pattern-forming objects is improved such that it can be easier to ship and use the present pattern-forming objects.

In concrete, as the additive having the antibacterial activity, various kinds of what can be added to agar can be used and, for example, a preservative agent, a fungicide, an antibacterial agent, and so on can be named. Since the object of the additive cannot be achieved if the amount is too little and an issue that shape retention capability of the pattern-forming objects of material gelled with agar may deteriorate can be caused if the amount is too much, the addition amount of these additives may be determined as appropriate by balancing out these factors.

In the group of present pattern-forming objects, the pattern-forming objects having different shear strengths may be included.

In this way, when the coating material composition for forming a pattern formed with the group of present pattern-forming objects and the coating-film-forming composition is applied by the trowel or the like with force (mainly shear force) being applied, differences are caused in collapse conditions of the pattern-forming objects having different shear strengths.

Therefore, when the group of present pattern-forming objects includes pattern-forming objects having different shear strengths, different collapse conditions of the pattern-forming objects are yielded, thereby enabling to form a variety of patterns. Here, that the shear strengths of the pattern-forming objects are different is that a degree of collapse thereof differs if they are sandwiched between a static face (wall face) and a moving face (trowel face) to move in parallel with the static face.

Here, that the group of present pattern-forming objects includes pattern-forming objects having different shear strengths may mean that at least one of the group of present pattern-forming objects has a different shear strength from what another of the group of present pattern-forming objects has, and may include a condition that all of the group of present pattern-forming objects have different shear strengths, respectively and a condition that some of the group of present pattern-forming objects have the same shear strength (for example, 15 of pattern-forming objects constituting the group of present pattern-forming objects may be comprised of 10 of the pattern-forming objects having a first shear strength and 5 of the pattern-forming objects having a second shear strength, which is different from the first shear strength.).

With respect to the group of present pattern-forming objects, the pattern-forming objects may be stable in a temperature range of 5 to 40 ° C.

Since the group of present pattern-forming objects is used to form the coating material composition for forming a pattern together with the coating-film-forming composition, it is preferable that the group of present pattern-forming objects should not be changed much if exposed to similar environments in which paints and the like are normally stored, shipped, and applied. One of the environmental factors which greatly affect the pattern-forming objects of material gelled with agar is the temperature change and the temperature range in which they are normally stored, shipped, and applied is expected to be a range from 5° C. to 40° C. such that it is preferable that the pattern-forming objects are stable in such temperature range. Here, being stable in such temperature range means not causing irreversible changes such as significant deformation and dissolution by the temperature change within such temperature range.

In the group of present pattern-forming objects, pattern-forming objects having different maximum sizes may be included.

The size of the pattern-forming object is a distance between two parallel planes across the pattern-forming object as outer faces of the pattern-forming object contact the two parallel planes, respectively, and the maximum size is the maximum value of the sizes obtained when the pattern-forming object is oriented in all directions with respect to the two parallel planes and the minimum size is the minimum value of the sizes obtained when the pattern-forming object is oriented in all directions with respect to the two parallel planes (for example, if the pattern-forming object is a sphere having a radius r, both the maximum size and the minimum size are 2r. And if the pattern-forming object is a cube having an edge length of z, the maximum size is 3^{0.5}z and the minimum size is z.).

Thus, if the group of present pattern-forming objects includes pattern-forming objects having different maximum sizes, differences are caused in collapse conditions of the pattern-forming objects having different maximum sizes when the coating material composition for forming a pattern formed with the group of present pattern-forming objects and the coating-film-forming composition is applied by the trowel or the like with force (mainly shear force) being applied, thereby enabling to form a variety of patterns.

Here, that the group of present pattern-forming objects includes pattern-forming objects having different maximum sizes may mean that at least one of the group of present pattern-forming objects has a different maximum size from what another of the group of present pattern-forming objects has, and may include a condition that all of the group of present pattern-forming objects have different maximum sizes, respectively, and a condition that some of the group of present pattern-forming objects have the same maximum size (for example, 15 of pattern-forming objects constituting the group of present pattern-forming objects may be comprised of 10 of the pattern-forming objects having a first maximum size and 5 of the pattern-forming objects having a second maximum size, which is different from the first maximum size.).

In the group of present pattern-forming objects, the minimum size of the pattern-forming objects may range from 2 to 8 mm.

The minimum size herein being referred to is defined as described above.

Since an issue that the pattern-forming objects do not collapse as originally designed when the coating material composition for forming a pattern formed with the group of present pattern-forming objects and the coating-film-forming composition is applied by the trowel or the like with force (mainly shear force) being applied and an issue that shape retention capability of the pattern-forming objects during the processes before the application operation if the minimum size is too small while the application operation may be difficult if the minimum size is too big, the minimum size may be in such a range that these are well balanced, and normally the minimum size is preferably at least 2 mm and more preferably at least 3 mm, and is preferably not-exceeding 8 mm and more preferably not-exceeding 6 mm.

In the group of present pattern-forming objects, the range of the maximum sizes of the pattern-forming objects may be from 5 to 20 mm.

The maximum size herein being referred to is defined as described above.

Since the pattern-forming objects do not collapse as originally designed when the coating material composition for forming a pattern formed with the group of present pattern-forming objects and the coating-film-forming composition is applied by the trowel or the like with force (mainly shear force) being applied if the maximum size is too small while the application operation may be difficult if the maximum size is too big, the maximum size may be in such a range that these are well balanced, and normally the maximum size is preferably at least 5 mm and more preferably at least 6 mm, and is preferably not-exceeding 20 mm and more preferably not-exceeding 15 mm.

In the group of present pattern-forming objects, it is also possible to restore dried material (xeroge) to material gelled with agar (swelled material) by adding water thereto when the coating material composition for forming a pattern are formed for use together with the coating-film-forming composition while the dried material (xeroge) is prepared by drying the pattern-forming objects for storage and shipping since the pattern-forming objects are made of material gelled with agar.

The group of present pattern-forming objects can be used to form the coating material composition for forming a pattern as the present pattern-forming objects are dispersed into the coating-film-forming composition by being mixed with the coating-film-forming composition of water-based coating material to form the coating film, and it is possible to form a variety of patterns on the surface to which the coating material is applied since the present pattern-forming objects exhibit a different color from what the coating film formed with the coating-film-forming composition exhibits while the present pattern-forming objects included in the coating material composition collapse when the coating material composition is applied by the trowel or the like with force (mainly shear force) being applied.

That is, the coating material composition for forming a pattern (hereinafter, referred to as “present composition”) into which the group of present pattern-forming objects are combined is the coating material composition for forming a pattern being formed by including the coating-film-forming composition of water-based coating material to form the coating film and the group of present pattern-forming objects to exhibit a different color from what the coating film formed with the coating-film-forming composition.

As the coating-film-forming composition constituting the present composition, various kinds of water-based coating materials to form the coating film can be utilized, but the coating-film-forming composition is not limited thereto, while the emulsion type (acrylic acid resin based material, acrylic styrene copolymer based material, vinyl versatate based material, vinyl acetate copolymer based material, various synthetic rubber latex, and urethane resin based material, epoxy resin based material, solvent-free urethane resin, epoxy resin, silicone resin, colloidal silica, sodium silicate based material) exemplified as a bonding material cited from Japanese Patent No. 2832424 and various kinds of main materials, excluding synthetic-resin-solution-based material, defined by JIS A-6909 (coating materials for textured finishes of buildings) may be used freely by preparing them in accordance with desired color, texture, wearing comfort, and so on.

Also, since the coating-film-forming composition constituting the present composition cannot retain the present pattern-forming objects in the present composition if the viscosity is too low whereas the application operation becomes difficult and the present pattern-forming objects tend to easily collapse when the present pattern-forming objects are mixed with the coating-film-forming composition if the viscosity is too high, it is preferable to have such viscosity to balance these factors and the coating-film-forming composition normally may have such viscosity that the coating-film-forming composition can be applied onto a vertical flat surface to form a thickness of 1 to 7 mm.

In the present composition, the mass ratio (w1/W) of the group of pattern-forming objects (mass w1) in the coating material composition (mass W) may be from 0.03 to 0.15.

Since a pattern formed with the present pattern-forming objects is not formed enough if the ratio of the group of present pattern-forming objects is too low while workability of the application operation of the present composition deteriorates (it becomes more difficult to form stably the coating film.) if the ratio is too high, it is preferable to determine the range of the ratio such that these factors are well balanced. When the total mass of the present composition (the above coating material composition) is W (g) (including water content) and the mass of the group of present pattern-forming objects is w1 (g) (including water content), normally the mass ratio (w1/W) is preferably at least 0.03 and more preferably at least 0.05, and is preferably not-exceeding 0.15 and more preferably not-exceeding 0.10.

### BRIEF DESCRIPTION OF THE DRAWINGS

FIG. 1 is a flow diagram illustrating general experimental procedures in the embodiment of the present invention.

### DESCRIPTION OF PREFERRED EMBODIMENT

The coating material composition for forming a pattern (the present composition) into which the group of present pattern-forming objects are combined can be widely used because irregular and various patterns are formed on the surface (coating surface) by one-time application, and nothing is limited with respect to the kind and the location of the coating surface, the thickness, color, and area of the coating film formed with the present composition, the structure and size of the pattern and so on, but the coating material composition can be preferably used to form a layered pattern and a patchy pattern peculiar to wood material and stone material for construction of native lime rock based material called as limestone and marble stone (marble) being in high demand in recent years, as described later, and a multicolored pattern resembling partial color changes during the firing process of the work such as fired brick on walls, pillars, and floors of the building. In particular, the present composition can be quite conveniently used to form these patterns by one-time application as one package of coating material in the construction field.

Since a multicolored layered pattern, a patchy pattern, and a pattern by color change during firing appearing on a limestone-based stone material for construction, a wood material, a fired brick, and so on have an enriched texture and make many people have a good feeling and feel the mystery of a production process thereof, a fired brick and a sheet material machined and cut from a raw stone and a raw wood are widely used in the same manner as a native-granite-based building material, which may be called as “mikageishi (granite)” in Japan, is used.

However, it may be difficult to use the genuine lime-rock based stone material for construction, the wood material, and the fired brick because of the costs or the like such that the present composition is quite useful in the point that a layered pattern, a patchy pattern, and a pattern by color change during firing peculiar to the limestone-based stone material for construction, the wood material, the fired brick can be obtained by using the present composition.

Individual present pattern-forming objects constituting the group of present pattern-forming objects are material gelled with agar and, with respect to the material gelled with agar, many blocks in a rectangular parallelepiped shape of agar-gelled material are included in “mitsumame (mixture of boiled beans, jelly, fruit pieces and molasses)” having long been eaten. The present inventor found that blocks of agar-gelled material thrown into a liquid tend to retain their shapes rather strongly, but easily collapse, or are crushed or broken by the shear force if they are applied in a sliding motion by a trowel. The present inventor further found that the agar-gelled material can be easily colored by a pigment or a coloring agent and if the thus-colored agar-gelled material is applied in the sliding motion by the trowel, a multi-colored pattern is formed by spreading large or small colored particles in a layered manner, in a mottled manner, or in a continuing blotch manner, or occasionally in a mixed manner thereof as respective blocks of agar-gelled material collapse, and are crushed and broken. If colors, sizes, shapes, and the like of the present pattern-forming objects are selected as appropriate, a multicolored pattern such as a layered pattern, a mottled pattern, or a pattern by color change during firing is formed because each of the present pattern-forming objects (gelled material) collapses, and is crushed and broken and then is fixed to the coating film formed with the coating-film-forming composition when the present composition combined with the present pattern-forming objects is applied in the sliding motion by the trowel.

Each of the present pattern-forming objects constituting the group of present pattern-forming objects is made of material gelled with agar and the agar-gelled material is quite suitable for the present pattern-forming objects since it is insoluble with water, solvent, and additive included in the coating-film-forming composition (water-based coating material) in a mixing (kneading) process with the coating-film-forming composition having such viscosity that it can be applied in a thickness of 1 to 7 mm on a vertical flat surface, at a temperature during storage and shipping, and at a temperature during application operation, and the objects of agar-gelled material tend to retain their shapes and sizes while the objects of agar-gelled material tend to easily lose their shapes and be torn by the shear force during application with the trowel, and such properties are retained in a temperature range from 5 to 40° C.

It is possible to select as appropriate quality and quantity to be combined of the agar suitable for preparation of the present pattern-forming objects and solid agar or powder agar may be used as the agar. And the combination amount of the agar suitable for the present pattern-forming objects may be within a range balanced well to the desired extent to satisfy both (1) shape retention prior to the application operation and (2) easy collapse during the application operation (When the combination amount of the agar is increased, the condition (1) becomes more satisfied and the condition (2) becomes more difficult to be satisfied, and conversely the condition (1) becomes more difficult to be satisfied and the condition (2) becomes more satisfied when the combination amount of the agar is decreased.), and normally, the combination amount is preferably at least 1 wt % and more preferably at least 2 wt % while it is preferably not-exceeding 5 wt % and more preferably not-exceeding 4 wt % (weight % of the dry mass (v2 (g)) of agar in the present pattern-forming objects (mass v1 (g)) including water content, the dry mass being combined thereinto).

And, if the group of present pattern-forming objects is configured to include pattern-forming objects exhibiting different colors, a multicolored pattern can be formed as the present pattern-forming objects included therein exhibit mutually different colors when the coating material composition for forming a pattern formed by mixing the group of present pattern-forming objects and the coating-film-forming composition is applied by the trowel or the like with force (mainly shear force) being applied.

It is possible to form a pattern exhibiting a desired color if the present pattern-forming objects are configured to include a pigment or a coloring agent.

As the pigment or the coloring agent, it is possible to use what is normally used for the coating material including a body pigment, and it is preferable to make a selection in consideration of the weather resistance if the present composition is used for the exterior of the building. Further, it is preferable not to use what may cause unfavorable reactions (for example, chemical reaction, physical reaction, and the like) with the agar included in the present pattern-forming objects.

If one of the present pattern-forming objects is configured to include powdered or granular aggregate, it is possible to contribute to compatibility of (1) shape retention prior to the application operation and (2) easy collapse during the application operation, and, in addition, it is also possible to give color to the present pattern-forming objects if colored aggregate is used, and further it is also useful to obtain the present pattern-forming objects having at least two desired colors. Furthermore, it is also possible to tune roughness and texture (affects the roughness and texture of the coating film on which the present pattern-forming objects exist) of the present pattern-forming objects by selection of the particle size of the aggregate.

A native aggregate, an artificial aggregate, a lightweight aggregate, and the like can be named as an applicable aggregate, and, if a polarized aggregate such as mica powder, pearl powder, and the like is used, it is also possible to make the pattern have a special texture, the pattern being formed with the present pattern-forming objects.

If the present pattern-forming objects constituting the group of present pattern-forming objects are prepared as both what includes the aggregate and what does not include the aggregate, in addition to the existence of differences in collapse conditions during the application operation, some portions, in which the pattern-forming objects including the aggregate exist, exhibit roughness caused by the aggregate while other portions, in which the pattern-forming objects not including the aggregate exist, exhibit no roughness caused by the aggregate, and, as a result, a variety of patterns and conditions of the coating film surface can be made.

If the color exhibited by the pattern-forming objects including an aggregate and the color of the aggregate are configured to be the same type of color, in the coating film formed with the present composition, particles of the aggregate having a similar color with that exhibited by the present pattern-forming objects can be selectively arranged in a neighboring area around the present pattern-forming objects. And if the particle size of the aggregate is configured to be larger than the thickness of the coating film formed with the present composition, it is possible to form a bug-eaten recess on a portion, where the aggregate rolls by the movement of the trowel at the time of application operation.

If the present pattern-forming objects are configured to include an antibacterial additive, it is possible to improve the preserving property of the present pattern-forming objects. As the additive, concretely speaking, a preservative agent, an antifungus agent, an antibacterial agent, and the like are named as examples.

If the group of present pattern-forming objects is configured to include the pattern-forming objects having different shear strengths, it is possible to adjust shapes, sizes, and the like of a pattern on the coating film by making the present pattern-forming objects having a mottled pattern with a certain color more difficult to collapse than the present pattern-forming objects having a continuing mottled pattern with another color, it is possible to adjust shapes, sizes, and the like of a pattern on the coating film. As a concrete example, some colors constitute a mottled pattern and some other colors constitute a continuing blotched pattern in a pattern of a native limestone-based building material and a pattern of a timber and a pattern by color change during firing and such patterns may be formed by utilizing them.

If the present pattern-forming objects are stable in a temperature range of 5 to 40° C., it is not likely that the temperature would limit storage, shipping, and application operation of the present composition such that the range of application of the group of present pattern-forming objects and the present composition into which it is combined.

If the group of present pattern-forming objects include pattern-forming objects having different maximum sizes, and if the size of present pattern-forming objects having some color is made large while the size of present pattern-forming objects having some other color is made small, it is possible to prepare a multicolored pattern formed on the coating film formed with the present composition such that colors constituting the pattern has respective sizes and lengths by the color.

If the minimum size of the present pattern-forming objects constituting the group of present pattern-forming objects ranges from 2 to 8 mm, the application operation is easy and it is possible to form successfully a pattern since the pattern-forming objects successfully collapse during the application operation.

If the maximum size of the present pattern-forming objects constituting the group of present pattern-forming objects ranges from 5 to 20 mm, the application operation is easy and it is possible to form successfully a pattern since the pattern-forming objects successfully collapse during the application operation. And it is also possible to successfully prepare a pattern of desirable sizes (for example, width of a layer in a layered pattern, length of a continuing blotched pattern, size of mottled pattern or color-change-during-firing pattern, and so on) to be formed on the coating film formed with the present composition. In particular, if the maximum size is configured to range from 7 to 12 mm, application workability is increased when the present composition is applied with the trowel and it is also possible to easily prepare desirable shapes of formed a pattern by the movement of the trowel.

If the group of present pattern-forming objects is configured to become dried material (xeroge), it is possible to form the present composition by mixing the present pattern-forming objects with the coating-film-forming composition after the dried material is made to be material gelled with agar (present pattern-forming object) by adding water thereto, and it is also possible to mixing the dried material as it is with the coating-film-forming composition in order to form the present composition (the dried material absorbs water content of the coating-film-forming composition to return to the gelled material).

In the coating material composition for forming a pattern (present composition) prepared by mixing the group of present pattern-forming objects and the coating-film-forming composition, it is possible to manage an amount of pattern on the coating film formed with the present composition by conducting an appropriate selection of the ratio of mixing (kneading) the group of present pattern-forming objects and the coating-film-forming composition. When the total mass of the present composition is W (g) and the mass of the group of present pattern-forming objects included therein is w1 (g), the mass ratio (w1/W) normally ranges from 0.03 (3%) to 0.15 (15%). Here, both W (g) and w1 (g) are mass including water content.

The coating material composition for forming a pattern (present composition) prepared by mixing the group of present pattern-forming objects and the coating-film-forming composition can be made to be the coating material for forming multicolored coating film as desired by selecting an appropriate coating-film-forming composition according to overall hue, texture, wearing comfort of a multicolored patterned coating film at a predetermined time, and by gently kneading thereinto the group of present pattern-forming objects with which color, size, combination amount, and easiness of collapse are selected as appropriate. This coating material (present composition) can be provided in one-package form and it is possible to form a coating film having thickness of 1 to 7 mm by one-time application. It is preferable that the gentle kneading is conducted with a mixer having a plate blade, a stir bar, or the like at a low rotational speed of about 30 to 60 revolutions per minute such that shapes and sizes of the present pattern-forming objects may not collapse.

### Embodiment

In the following, embodiments will be described to explain concretely the present invention. However, the present invention should not be limited by these embodiments.

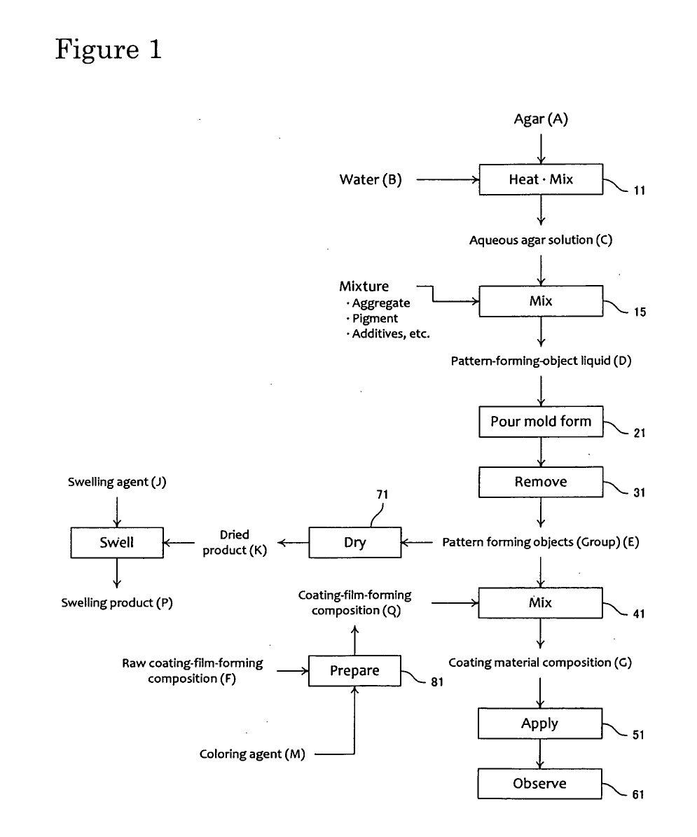

FIG. 1 is a flow diagram showing general operations in an embodiment of the present application. The general operations in the embodiment will be explained with reference to FIG. 1.

Agar (A) of powder dried agar or block dried agar which is commercially available is prepared. Here, in concrete, the product name of “Kona-kanten (powder agar)” of Kabushiki Kaisha Pioneer Kikaku was used for the powder dried agar and the product name of “Clean kanten (abbreviate)” of Kaneei Fujimori Co, Ltd, was used for the block dried agar.

A predetermined amount of agar (A) and a predetermined amount of purified water (B) were mixed, and heated (around a range of about 90° C. to 100° C.) to make the agar (A) dissolved completely (heating-mixing process 11), and an aqueous agar solution (C) was prepared (Here, a preferable concentration of agar (A) in the aqueous agar solution (C) is normally 1 to 5 wt %.).

The thus-prepared aqueous agar solution (C) was cooled at about 40° C., and were stirred as the temperature was kept at about 40° C. while a mixture of aggregate, pigment, additive, and so on as prescribed in each embodiment was mixed into the aqueous agar solution (C) (mixing process 15) (Each mixture of necessary aggregate, pigment, and additive was added to the aqueous agar solution (C) according to each embodiment.).

It was continuously stirred for about 10 more minutes such that the mixture and the aqueous agar solution (C) were mixed well and a pattern-forming-object liquid (D) was prepared.

Then, the pattern-forming-object liquid (D) was poured into inside spaces of a mold form having a plurality of inside spaces of a cubic geometry (dice shape) having about 4 mm of each edge length (mold form pouring process 21), and cooled naturally in an environment at a room temperature (about 25° C.) (The pattern-forming-object liquid (D) was gelled to become pattern-forming object (E) by the cooling process.).

Then, the gelled pattern-forming object (E) was removed from the mold form (removal process 31) so as to obtain a group of pattern-forming objects (E). The group of pattern-forming objects (E) was constituted of these plural pattern-forming objects (E).

Here, the pattern-forming objects (E) which were removed from the mold form were stored in water (The water amount was enough to submerge each of the pattern-forming objects (E).) such that each of the pattern-forming objects (E) could be suspended (it could be prevented to adhere each other) except in the dry process 71 to be described later since respective pattern-forming objects (E) are easy to adhere each other if they are left in a condition of adjoining directly each other. Here, it is necessary to care about preservation of water for storage if the storage period of storing the pattern-forming objects (E) in the water becomes long.

In some of the embodiments (more specifically, first dried product (K-1) and second dried product (K2)), the group of pattern-forming objects (E) were dried in the dry process 71 to form the dried product (K) (xeroge). In the dry process 71, in concrete, the pattern-forming objects removed from the mold form in the removal process 31 were spread on a piece of paper and dried naturally at the room temperature (about 25° C.) for about 48 hours.

The dried product (K) (xeroge) was made to be swelled product (P) by dipping it in a sufficient amount of swelling agent (J) (It was the swelling agent that swelled the dried product (K) (xeroge) to be in a gelled condition again. Specifically, purified water was used.) for each dried product (K) to be dipped thereinto for 30 minutes before using (before being provided to the mixing process 41 to be described later)

Then, the thus-obtained group of pattern forming objects (E) and swelled product (P), and the coating-film-forming composition (Q) were mixed (mixing process 41) to prepare coating material composition (G).

The coating-film-forming composition (Q) was prepared by mixing and stirring the raw coating-film-forming composition (F) constituted of aqueous coating material and a coloring agent and the like (M) (preparing process 81). As the raw coating-film-forming composition (F), two kinds of a main material of the exterior thin-coating material of JIS A6909 (Specifically, it was white sand-wall-type resin lithin of Toyo Kasei Kabushiki Kaisha. Hereinafter, it is referred to as “first raw coating-film-forming composition (F-1)”.) and water-based coating material disclosed in Japanese Patent No. 2832424 (Specifically, it was a binding agent of Toyo Kasei Kabushiki Kaisha into which white aggregate fine grain was mixed. Hereinafter, it is referred to as “second raw coating-film-forming composition (F-2)) were used. A coloring agent or the like (M) was added as appropriate in order to give a desired color to the coating-film-forming composition (Q).

The group of pattern-forming objects (E) used in the mixing process 41 was weighed by scooping the pattern-forming objects (E) suspended in the water with a sieve basket or a screen to remove the water and provided to the mixing process 41. And then the swelled product (P) used in the mixing process 41 was also weighed and provided to the mixing process 41.

Also, the mixing (kneading) in the mixing process 41 was conducted with a mixer having a plate blade, a stir bar, or the like at a low rotational speed of about 30 to 60 revolutions per minute such that individual pattern-forming objects constituting the group of pattern-forming objects (E) and swelled product (P) were not crushed or did not collapse.

The thus-obtained coating material composition (G) was actually applied on a surface to be coated (coating process 51), and then the coating film was observed 61. Further, the thus-obtained coating material composition (G) was applied on an actual building and the working conditions were observed.

First, concrete compositions of the group of pattern-forming objects (E) and the group of pattern-forming objects (E) to be provided to the drying process 71 in order to form the dried product (K) are described, respectively. The following numerals are shown in wt % unless otherwise noted.

### (First Group of Pattern-Forming Objects (E-1)): Colored in Gray

| | |
|---|---|
| Water (B) | 49.4 |
| Powder dried agar (A) | 2.0 |
| Aggregate | 48.4 |
| Pigment | 0.1 |
| Additive (antibacterial agent) | 0.1 |
| Total | 100.0 |

Here, as the aggregate, in concrete, Kansuiseki [white marble] (granular marble) of CALFINE CO., LTD. (translucent white native aggregate (particle size: 0.1 to 0.5 mm)) was used, as the pigment, in concrete, “BLACK SD-9020” (black water-dispersed pigment) of DIC Corporation was used, and as the antibacterial agent, in concrete, “Topside 288” of Permachem Asia, Ltd. was used.

### (First Dried Product (K-1)): Colored in Brown

| | |
|---|---|
| Water (B) | 49.4 |
| Powder dried agar (A) | 2.0 |
| Brown artificial aggregate | 41.5 |
| Dark gray artificial aggregate | 7.0 |
| Antibacterial agent | 0.1 |
| Total | 100.0 |

Here, as the brown artificial aggregate, in concrete, “Colorsand 20R-202” (particle size: 0.1 to 0.5 mm) of SHINTOH TOHRYOH Co, Ltd. was used, as the dark gray artificial aggregate, in concrete, “Colorsand N-1” (particle size: 0.1 to 0.5 mm) of SHINTOH TOHRYOH Co, Ltd. was used, and as the antibacterial agent, in concrete, “Topside 288” of Permachem Asia, Ltd. was used.

### (Second Group of Pattern-Forming Objects (E⁻2)): Colored in Bright Reddish Brown

| | |
|---|---|
| Water (B) | 94.9 |
| Block dried agar (A) | 3.6 |
| Pigment | 1.4 |
| Antibacterial agent | 0.1 |
| Total | 100.0 |

Here, as the pigment, in concrete, “PSM Brown #95” (bright reddish brown water-dispersed pigment) of Mikuni Color Ltd. was used and as the antibacterial agent, in concrete, “Topside 288” of Permachem Asia, Ltd. was used.

### (Second Dried Product (K-2)): Colored in Dark Brown

| | |
|---|---|
| Water (B) | 49.0 |
| Block dried agar (A) | 2.0 |
| Reddish brown artificial aggregate | 45.8 |
| Black water-dispersed pigment | 0.1 |
| Dark brown artificial aggregate | 3.0 |
| Antibacterial agent | 0.1 |
| Total | 100.0 |

Here, as the reddish brown artificial aggregate, in concrete, “Colorsand 20R-202” (particle size: 0.1 to 0.5 mm) of SHINTOH TOHRYOH Co, Ltd. was used, as the dark brown artificial aggregate, in concrete, colored aggregate #998 (particle size: 2 mm) of Toyo Kasei Kabushiki Kaisha, as the black water-dispersed pigment, in concrete, “BLACK SD-9020” (black water-dispersed pigment) of DIC Corporation was used, and as the antibacterial agent, in concrete, “Topside 288” of Permachem Asia, Ltd. was used.

Then, these four of first group of pattern-forming objects (E-1), second group of pattern-forming objects (E-2), first dried product (K-1), and second dried product (K-2) were used, and the coating-film-forming composition (Q) were mixed with these (mixing process 41) to prepare the coating material composition (G). Here, as described above, before being provided to the mixing process 41, the first dried product (K-1) and the second dried product (K-2) were dipped into the swelling agent (J) (purified water) for about 30 minutes (swelling process 76) to form the swelled product (P) (A swelled product of the first dried product (K-1) is referred to as first swelled product (P-1) and a swelled product of the second dried product (K-2) is referred to as the first swelled product (P-2).).

In the compositions of the coating material compositions as shown below, the mass was recited as gelled material including water with respect to all of the first group of pattern-forming objects (E-1), the second group of pattern-forming objects (E-2), the first swelled product (P-1), and the second swelled product (P-2).

And each of the coating material compositions (G) was applied to a surface to be coated (application process 51), and then the coating film (about 2 mm in thickness) was observed 61.

### (First Coating Material Composition (G-1))

With the first coating material composition (G-1), a limestone-like pattern having brown and gray layered patterns on the ivory base material was formed.

First, in the preparation process 81, 91.3 (g) of first raw coating-film-forming composition (F-1) as the raw coating-film-forming composition (F) was used and mixed with 0.5 (g) of coloring agent (M) for adding a color to the ivory color (As the coloring agent, in concrete, PSM Yellow #85 (0.45 g) of Mikuni Color Ltd. and BLACK SD-9020 (0.05 g) of DIC Corporation were used.), and the mixture was well stirred to form an ivory first coating-film-forming composition (Q-1), and, utilizing this, a first coating material composition (G-1) was prepared according to the following composition details.

| | |
|---|---|
| Ivory first coating-film-forming composition (Q-1) | 91.8 |
| First group of pattern-forming objects (E-1) | 1.0 |
| First swelled product (P-1) | 6.3 |
| Second swelled product (P-2) | 0.9 |
| Total | 100.0 |

When the first coating material composition (G-1) was applied to a surface to be coated (application process 51), a layered pattern was formed by moving the trowel in one direction, either vertical direction or horizontal direction, the movement of the trowel determining the shape of the pattern. The finished color pattern was a limestone-like pattern having a brown and gray layered pattern on the ivory base material, dark brown speckles were scattered thereon, and pieces of brown aggregate having 2-mm-particle-size and concaved portions like bug-eaten holes formed by the movement of the trowel causing the pieces to roll appeared only near brown pattern-forming objects.

### (Second Coating Material Composition (G-2))

A fired-brick-like pattern having a speckled pattern with bright reddish brown and dark brown speckles were formed.

First, in the preparation process 81, 92.8 (g) of first raw coating-film-forming composition (F-1) as the raw coating-film-forming composition (F) was used and mixed with 2 (g) of coloring agent (M) for adding a brick color (As the coloring agent, in concrete, PSM Yellow #95 (1.9 g) of Mikuni Color Ltd. and BLACK SD-9020 (0.1 g) of DIC Corporation were used.), and the mixture was well stirred to form a brick-red second coating-film-forming composition (Q-2), and, utilizing this, a second coating material composition (G-2) was prepared according to the following composition details.

| | |
|---|---|
| Brick-red second coating-film-forming composition (Q-2) | 94.8 |
| Second group of pattern-forming objects (E-2) | 2.5 |
| Second swelled product (P-2) | 2.7 |
| Total | 100.0 |

When the second coating material composition (G-2) was applied to a surface to be coated (application process 51), the second coating material composition (G-2) was first applied evenly by the trowel and left for a while to let it dry partially, and then the trowel was moved in a vertical direction and a horizontal direction to crush the pattern-forming material (the second group of pattern-forming objects (E-2) and the second swelled product (P-2)) such that breakage of the pattern-forming material (the second group of pattern-forming objects (E-2) and the second swelled product (P-2)) was made not so much. Brick-like felt roughness was adjustably prepared by roughness of the aggregate of the brick-red second coating-film-forming composition (Q-2).

The finished color pattern was a bright reddish brown mottled pattern and a dark brown mottled pattern on a brick red course-feeling base material, and, only near dark brown mottled patterns, pieces of the dark brown aggregate were scattered and concaved portions like bug-eaten holes formed by the movement of the trowel causing the pieces to roll appeared.

### (Third Coating Material Composition (G-3))

A woodtone pattern of hinoki (Chamaecyparis obtusa) plate was formed.

First, in the preparation process 81, 92.2 (g) of second raw coating-film-forming composition (F-2) as the raw coating-film-forming composition (F) was used and mixed with 1.6 (g) of coloring agent (M) for giving a hinoki-plate color (As the coloring agent, in concrete, colored aggregate #480 of Toyo Kasei Kabushiki Kaisha was used.), and the mixture was well stirred to form a hikoki-plate color third coating-film-forming composition (Q-3), and, utilizing this, a third coating material composition (G-3) was prepared according to the following composition details.

| | |
|---|---|
| Hinoki-plate color third coating-film-forming composition (Q-3) | 93.8 |
| First group of pattern-forming objects (E-1) | 0.6 |
| First swelled product (P-1) | 5.0 |
| Second group of pattern-forming objects (E-2) | 0.6 |
| Total | 100.0 |

When the third coating material composition (G-3) was applied to a surface to be coated (application process 51), the third coating material composition (G-3) was first applied evenly by the trowel and left for a while to let it dry partially, and then the trowel was moved in one direction, a vertical direction or a horizontal direction, to crush the pattern-forming material (the first group of pattern-forming objects (E-1), the first swelled product (P-1), and the second group of pattern-forming objects (E-2)) to form a layered pattern wherein the movement of the trowel controlled shapes of the pattern.

The finished color pattern was a woodgrain pattern of non-radial-cut of hinoki, in which a brown layered pattern and a gray and bright reddish brown mottled pattern appeared on a base material of hinoki-plate color.

Finally, the first coating material composition (G-1), the second coating material composition (G-2), and the third coating material composition (G-3) were applied to an actual building and the conditions of applied compositions were observed.

### (Application Example 1): First Coating Material Composition (G-1)

On a large cylinder made of concrete inside, a surface on which was prepared beforehand, the first coating material composition (G-1) was applied a little less than 2 mm thick by the trowel, and the pattern-forming material (the first group of pattern-forming objects (E-1), the first swelled product (P-1), and the second swelled product (P-2)) was deformed and broken by the shear force of trowel movement in a horizontal direction such that large and small particles were spread in the horizontal direction to form a multicolored pattern coating film having a layered pattern and about 2 mm thickness on the cylinder, which looked like a pattern of the natural limestone and had a brown and gray layered pattern in a horizontal direction on an ivory base material with a dark brown mottled pattern scattered thereon and was provided with bug-eaten holes only near dark brown mottles.

### (Application Example 2): Second Coating Material Composition (G-2)

On a wall of an exterior, a surface on which was prepared beforehand, a whitish coating material was applied beforehand and left for drying; a joint layout was made by placing thereon a thin adhesive tape having a predetermined width of joint in a size of a brick; the second coating material composition (G-2) was applied about 2 mm thick on the entire surface of the wall including the joint by the trowel and left for drying a little bit; shapes of the pattern-forming material were deformed and broken by the shear force of the trowel movement in both horizontal and vertical directions such that large and small particles were spread to form a coating film surface having a bright reddish brown mottled pattern and a dark brown mottled pattern and provided with bug-eaten holes only near dark brown mottles; the adhesive tape was removed before the coating material was dried and hardened; weather-resistant resin liquid, which would be clear after drying, was applied to the entire surface of the wall including the joint after the coating material was well dried and hardened; and a multicolored pattern coating film having 1.5 mm thickness and the whitish joint as part of design, and appearing like a fired brick was formed.

### (Application Example 3): Third Coating Material Composition (G-3)

On a floor of an interior, a surface on which was prepared beforehand, a coating material for a floor having a predetermined color of joint was applied beforehand and left for drying; a joint layout was made by placing thereon a thin and shred-resistant adhesive tape having a predetermined width of joint in a predetermined size and shape; the third coating material composition (G-3) was applied about 2 mm thick on the entire surface of the floor including the joint by the trowel and left for drying a little bit; shapes of the pattern-forming material were deformed and broken by the shear force of the trowel movement in the same direction such that large and small particles were spread to form a coating film surface having a woodgrain; the adhesive tape was removed before the coating material was dried and hardened; unnecessary coating material left on the surrounding coating film after removal of the adhesive tape was vacuumed and removed by a vacuum cleaner or the like after completion of hardening of the coating material; wear-resistant and impact-resistant resin liquid, which would be clear after drying, was applied to the entire surface of the floor including the joint; and a multicolored pattern coating film having about 2 mm thickness and the joint as part of design, and appearing like a woodgrain was formed.

As described above, the first group of pattern-forming objects (E-1) and the second group of pattern-forming objects (E-2) are referred to a group of pattern-forming objects to be combined into the coating material composition (G) including a plurality of pattern-forming objects of gelled material with the agar (A).

And a group of pattern-forming objects mixed with the first group of pattern-forming objects (E-1) and the second group of pattern-forming objects (E-2) like the combination of the third coating material composition (G-3) includes pattern-forming objects in different colors: the first group of pattern-forming objects in gray color (E-1) and the second group of pattern-forming objects in reddish brown color (E-2).

And both the first group of pattern-forming objects (E-1) and the second group of pattern-forming objects (E-2) include pigment.

The first group of pattern-forming objects (E-1) is a group in which at least part (all in this example) of the pattern-forming objects includes powder or granular aggregate. Since the second group of pattern-forming objects (E-2) is composed only of the pattern-forming objects that do not include the aggregate, a group of pattern-forming objects mixed with the first group of pattern-forming objects (E-1) and the second group of pattern-forming objects (E-2) like the combination of the third coating material composition (G-3) comprises a mixture of the pattern-forming objects including the aggregate (E-1) and the pattern-forming objects not including the aggregate (E-2).

In the second swelled product (P-2) (group of pattern-forming objects) of the second dried product (K-2), the color (dark brown) that the pattern-forming objects including the aggregate exhibit and the color (dark brown) that the aggregate exhibits are the same type of color. Specifically, the color (dark brown) that the pattern-forming objects including the aggregate exhibit and the color (dark brown) that the aggregate exhibits are in the same hue in the hue arrangement of the Munsell color system (10 hues).

In both first group of pattern-forming objects (E-1) and second group of pattern-forming objects (E-2), the pattern-forming objects include antibacterial additive (antibacterial agent).

A group of pattern-forming objects mixed with the first group of pattern-forming objects (E-1) and the second group of pattern-forming objects (E-2) like the combination of the third coating material composition (G-3) includes pattern-forming objects having different shear strengths (the shear strength of the second group of pattern-forming objects (E-2) is higher than that of the first group of pattern-forming objects (E-1)).

Both of the first group of pattern-forming objects (E-1) and the second group of pattern-forming objects (E-2) comprises pattern-forming objects being stable in a temperature range of 5 to 40° C.

Here, both of the first group of pattern-forming objects (E-1) and the second group of pattern-forming objects (E-2) have a general cube geometry having about 4 mm edge length and the maximum sizes thereof are approximately the same, but the maximum sized thereof may be different by changing the sizes of the mold forms utilized in the mold form pouring process 21.

Both of the first group of pattern-forming objects (E-1) and the second group of pattern-forming objects (E-2) have the minimum size of the pattern-forming objects of 2 to 8 mm (about 4 mm) and the maximum size of the pattern-forming objects of 5 to 20 mm (about 7 mm).

And both of the first dried product (K-1) and the second dried product (K-2) are a dried product formed by drying the group of present pattern-forming objects.

Any of the first coating material composition (G-1), the second coating material composition (G-2), and the third coating material composition (G-3) is a coating material composition for forming a pattern including a coating-film-forming composition comprising water-based coating material to form a coating film (in concrete, the ivory first coating-film-forming composition (Q-1) in the first coating material composition (G-1), the brick-red second coating-film-forming composition (Q-2) in the second coating material composition (G-2), and the hinoki-plate color third coating-film-forming composition (Q-3) in the third coating material composition (G-3)) and the group of present pattern-forming objects exhibiting different color from that of the coating film formed with the coating-film-forming composition and being dispersed in the coating-film-forming composition (in concrete, the first group of pattern-forming objects (E-1), the first swelled product (P-1), and the second swelled product (P-2) in the first coating material composition (G-1); the second group of pattern-forming objects (E-2) and the second swelled product (P-2) in the second coating material composition (G-2); and the first group of pattern-forming objects (E-1), the first swelled product (P-1), and the second group of pattern-forming objects (E-2) in the third coating material composition (G-2)).

And in the first coating material composition (G-1), the mass ratio (w1/W) of the group of pattern-forming objects (1.0 part of the group of first pattern-forming objects (E-1) plus 6.3 part of the first swelled product (P-1) plus 0.9 part of the second swelled product (P-2) equal to 8.2 part by weight (w1 in mass)) in the first coating material composition (G-1) (100 part by weight (W in mass)) is 0.082 (0.03 to 0.15).

In the second coating material composition (G-2), the mass ratio (w1/W) of the group of pattern-forming objects (2.5 part of the group of second pattern-forming objects (E-2) plus 2.7 part of the second swelled product (P-2) equal to 5.2 part by weight (w1 in mass)) in the second coating material composition (G-2) (100 part by weight (W in mass)) is 0.052 (0.03 to 0.15).

In the third coating material composition (G-3), the mass ratio (w1/W) of the group of pattern-forming objects (0.6 part of the group of first pattern-forming objects (E-1) plus 5.0 part of the first swelled product (P-1) plus 0.6 part of the group of second pattern-forming objects (E-2) equal to 6.2 part by weight (w1 in mass)) in the third coating material composition (G-3) (100 part by weight (W in mass)) is 0.062 (0.03 to 0.15).

As described above, the first coating material composition (G-1), the second coating material composition (G-2), and the third coating material composition (G-3) are a coating material prepared as a coating-film-forming composition of high viscosity by kneading the (group of) pattern-forming objects comprising granular objects having two or more different colors and being practically adjustable for coloration, texture, and easiness of collapse and breakage of shapes by the shear force caused by the trowel. And the coating material may be one package type. By only a normal application operation with the trowel, shapes of the (group of) pattern-forming objects are deformed and broken off such that large and small colored grains are spread on the surface or in the inside of the coating material and consolidated. Therefore, highly decorative multicolored coating film (this cannot be obtained by the technology in the prior art depending on the shape and size of the patterning material) such as a coating film having a layered pattern, a mottled pattern, and a pattern by color change during firing may be formed 1 to 7 mm thick by one-time application on the wall, the pillar, and the floor in the construction field, irrespective of shapes or quality of the base material.

In this way, the coating material composition of the present invention can be successfully used as one package type of coating material by one-time application to finish the surface with a multicolored pattern such as a layered patter and a mottled patter peculiar to the natural limestone type of building material and wood material, and a pattern by color change during firing peculiar to the fired brick.

The (group of) pattern-forming objects of the present invention is held in a stable condition in a temperature range of 5 to 40° C. such that it is possible to obtain a desired multicolored pattern in the construction field irrespective of the season.

And with respect to the coating composition of the present invention, the design performance of the coating film formed with the coating material of the present invention can be drastically improved by incorporating the joint with sense of using it and by a simple operation when the coating film is prepared.

The coating material composition of the present invention produces a multicolored pattern formed by spreading large and small colored grains on the surface of and in the inside of coating material as shapes of the pattern-forming objects are deformed and broken by the shear force caused by the trowel. Therefore, even the same worker use the same coating material performs the trowel application, the same pattern cannot be made in the same way of the pattern made by the nature. This effect can contribute to creation of design space having an enriched natural flavor, which cannot be obtained by the conventional paint or coating material, while the traditional techniques of the plasterer are utilized.

On the other hand, if similar patterns are desired, after the coating material composition of the present invention is applied evenly by the trowel and left for drying a little bit, then the following application method may be used. The trowel is moved with the same force as much as possible in the same direction to deform and break the shapes of the pattern-forming objects to spread on the surface of and in the inside of the coating material. This application method may be suitable for many cases. For example, many workers are engaged with the application operation of the same building such as a large building.

When a large column or a large prismatic column is incorporated in the architectural design specification, it is difficult to obtain the column itself from the natural resource such as rock and wood because of the costs and preservation of the nature except a special building such that most column is made of concrete or iron. This raw material is surely subject to a surface treatment for a long term preservation of the function and design. It is the most convenient and common to finish the surface with a conventional paint, but higher design performance may be often demanded. With respect to the prismatic column, it may be possible to achieve a high design performance for the ordinary cost by utilizing a plate material of the natural rock and wood and a porcelain tile. With respect to the circular column, however, it is necessary to spend several times or several ten times of the ordinary cost since a shape of the plate material of the natural rock and wood and the tile along a circular surface is required. The multicolored pattern of the present invention is formed with the coating material composition and applicable irrespective of the shapes of the building base material. Therefore, with respect to the column of the architectural design specification, it is considered to contribute to the design and the long term preservation of the function significantly.

In the case of building material of natural rock or wood and brick, the material, including the porcelain tile, is all cut or formed in a predetermined size. Therefore, a joint always exists when the building material is applied on a wall, a pillar, and a floor. This joint is intentionally incorporated for the design and it is not too much to say that the wall, the pillar, and the floor of the building in all ages and places are decorated with the joint. The finish with the coating material of the present invention also improves significantly the design performance by incorporating the joint intentionally with a simple operation.

The operation for incorporating the joint is simple. Before the coating material (coating material composition) is applied, a joint layout may be made by placing a thin and shred-resistant adhesive tape having a predetermined width of joint. The coating material may be applied on the entire surface including the joint. The adhesive tape may be removed before the coating material (coating material composition) is dried and hardened. At this time, the pattern-forming objects of the present invention are in condition of being deformed and broken such that the patterning material is readily cut on the edge of the removed tape and defects on the edge of the joint are not caused to form a clear joint.

The pattern-forming objects of the present invention is a coagulable water-soluble product and/or swelled-softened product and form patially the coating film by being consolidated on the surface of and in the inside of the coating-film-forming composition as large and small colored grains since their shapes and sizes are deformed and broken off. Therefore, the strength and the water-resistance of a portion in which the degree of breakage is low and grain size of the pattern is large may not satisfy the specification of the exterior wall surface after the coating material is dried. In such a case, weather-resistant resin liquid and the like, which will be clear after drying, may be applied to the entire surface of the coating film as a finish coating material for covering the case. In the case of the floor, irrespective of interior or exterior specification, wear-resistant and impact-resistant finish coating material may be applied for covering the case.

This type of pattern-forming object may be a granular (or block-like) solid material having a predetermined shape and size (dimension). For example, in the above embodiments, a cube geometry having about 4 mm edge length is utilized. However, various kind of geometries may be comprised of such as a sphere geometry, an oval sphere geometry, a rectangular parallelepiped geometry, a conic geometry, a pyramid geometry, a circular cone trapezoidal shape, a truncated pyramid geometry. The pattern-forming objects may be gelled material with a gelling agent. And the pattern-forming objects may be treated as a member to form the pattern. Further, when the group of pattern-forming objects comprising many pattern-forming objects is handled, not sides of individual pattern-forming objects, but a representative value in statics of many pattern-forming objects can be employed and treated as the size of the pattern-forming objects. For example, an average value (number average and weight average), a median value, and the like are named. These values may be treated equally to the sizes of individual pattern-forming objects and the average value is often used. The specified values in the specification may be preplaced with the average value and the like.

The agar useable in the present invention includes agar generally defined. For example, a freeze-dried viscous fluid of red algae (rhodophyta) such as agar-agar (agar-agar) and false ceylon mosses (gracilaria confervoides) may be included. The agar is, for example, used for gelling the culture media when tissue culture of plant and microorganism cultivation are conducted. The culture media gelled with the agar is called agar media. The agar also is used as a material for gel (jelly) as food. The agar is a chemically different substance from the gelatin made from beef or pork, but is common as a gelling agent. In general, the so-called solidification temperature of the agar as food is about 35 to 40° C., and it is easily solidified at a room temperature, and the so-called melting temperature is relatively high and about 85 to 95° C. On the other hand, the so-called solidification temperature of the gelatin as food is about 13° C., and it is usually solidified in a refrigerator, and the so-called melting temperature is relatively low and about 20 to 25° C. Therefore, the agar is more suitable for the present invention since it is superior in the high temperature strength to the gelatin. And if the mechanical properties in the same room temperature are reviewed, the agar is hard and brittle, but the gelatin is soft and adhesive. The gelling agent may include pectin, carrageenan, and the like from botanical origin other than the gelatin from animal origin and the agar from botanical origin. However, strength as the mechanical properties at the room temperature and stability (for example, not being readily soluble in water) of the agar is considered to be superior. The jelly is generally a material in a semi-solid condition and has such mechanical properties that it resists if pushed, but it is broken if a strong pressure is applied. The pattern-forming object of the present invention can have such a feature of the jelly. In the present invention, the agar can be used together with gelatin from animal origin and pectin, carrageenan, and the like from botanical origin. However, it is considered that the agar has the most preferable property.

### DESCRIPTION OF NOTATIONS

11 heating and mixing process
15 mixing process
21 pouring mold form process
31 removing process
41 mixing process
51 applying process
61 observing process
71 drying process
76 swelling process
81 preparing process

1. A group of pattern forming objects to be combined with a coating material composition comprising: a plurality of pattern-forming objects gelled with agar.

2. The group of pattern-forming objects according to claim 1, wherein the pattern-forming objects comprise different colors.

3. The group of pattern-forming objects according to claim 1, wherein the pattern forming objects comprise a pigment or a coloring agent.

4. The group of pattern-forming objects according to claim 1, wherein at least one of the pattern-forming objects comprises an aggregate in a powder state or in a granular state.

5. The group of pattern-forming materials according to claim 4, comprising pattern-forming objects not including the aggregate.

6. The group of pattern-forming objects according to claim 4, wherein a color exhibited by the pattern-forming objects including the aggregate and a color of the aggregate are a same type of color.

7. The group of pattern-forming objects according to claim 1, wherein the pattern-forming objects comprise an antibacterial additive.

8. The group of pattern-forming objects according to claim 1, comprising: pattern-forming objects having different shear strengths.

9. The group of pattern-forming objects according to claim 1, wherein the pattern-forming objects are stable in a temperature range of 5 to 40° C.

10. The group of pattern-forming objects according to claim 1, comprising: pattern-forming objects having different maximum sizes.

11. The group of pattern-forming objects according to claim 1, wherein a minimum size of the pattern-forming objects is from 2 to 8 mm.

12. The group of pattern-forming objects according to claim 1, wherein a maximum size of the pattern-forming objects is from 5 to 20 mm.

13. A dehydrated product of the group of pattern-forming objects recited in claim 1.

14. A coating material composition for forming a pattern, comprising:
a coating-film-forming composition including a water-based coating material for form a coating film; and
the group of pattern-forming objects recited in claim 1, wherein the group of pattern-forming objects are dispersed in the coating-film-forming composition and exhibit different color from that of the coating film formed with the coating-film-forming composition.

15. The coating material composition according to claim 14, wherein a weight ratio (w1/W) of the group of pattern-forming objects (mass w1) in the coating material composition (mass W) is from 0.03 to 0.15.
